(19) United States
(12) Patent Application Publication
(10) Pub. No.: US 2026/0156204 A1
(43) Pub. Date: Jun. 4, 2026

(54) Ultra secure and ultra high throughput communication conduit and system, with simultaneous communication and data transfer through multiple channels

(71) Applicant: Navtej Dhillon, Supply, NC (US)

(72) Inventor: Navtej Dhillon, Supply, NC (US)

(21) Appl. No.: 18/969,142

(22) Filed: Dec. 4, 2024

(51) Int. Cl. H04L 69/14

(52) U.S. Cl. CPC H04L 69/14

(57) ABSTRACT

Intend to invent and create, ultra secure and ultra high throughput communication conduit and system, with simultaneous communication and data transfer through multiple channels. This novel design and system will work for back haul communication, internet access on devices, operating systems, servers and device to device, application to application, program to program, communication. Further with the novel, broker, channel select, and protocol interplex newer unique ways of ultra secure communication are possible.

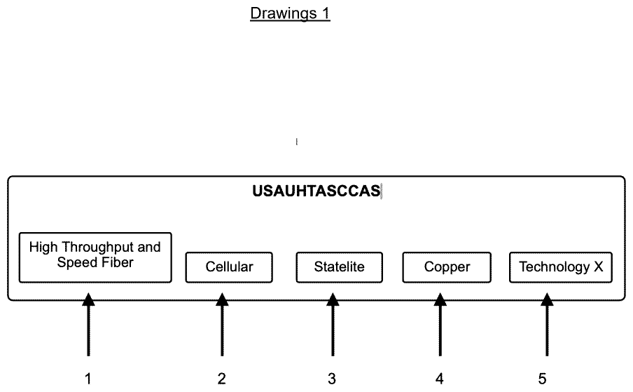

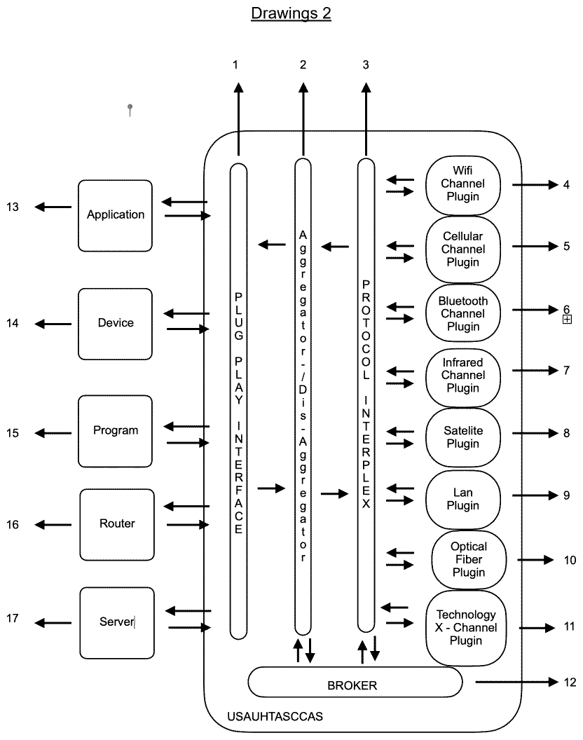

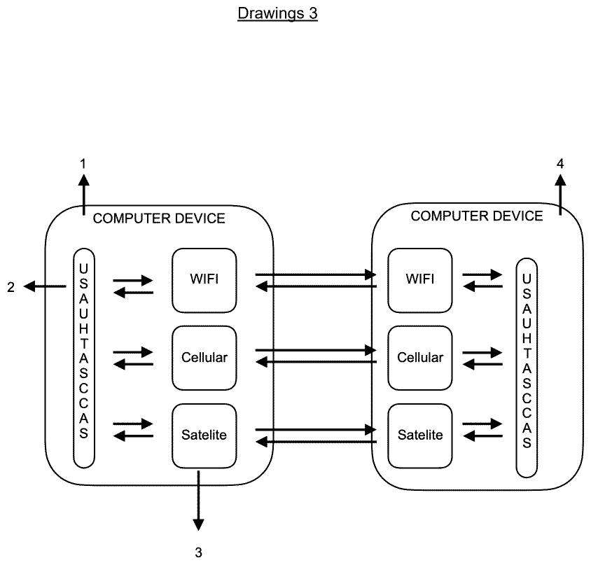

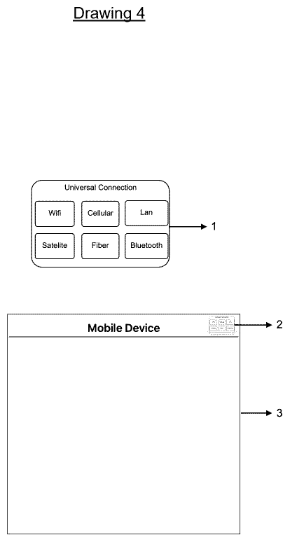

### CROSS-REFERENCE TO RELATED APPLICATIONS

None.

### BACKGROUND OF THE INVENTION

B.1 Currently computer or mobile devices, applications or programs at any particular time use only one channel to communicate or send data to and fro or to access internet in general terms. Here channel means an already established means of data transfer like cellular, wifi etc with respect to a device.

B.2 Currently for back all communication, most of the communication uses only one channel for data transfer. Here channel means, the communication medium like the fiber optic, satellite, copper etc.

B.3 As of today, as all the data is sent through one channel, the data throughput is not maxed out as the applications are using only one channel at a time.

B.4 There exists not a program or system which can make the data transfer possible to use all the available communication channels for a device. And for the back haul communication, there exists not a way which can dictate which communication channel should be used, and also route or spread out between different channels. Also it is not possible for the same device to route and work on multiple channels at the same time.

B.5 There exists not a program or system which can select which channel the communication should restrict to, and further as there are now higher speed channels compared to others, be able to specifically select a channel.

B.6 Traditionally, so far the routing devices, switches have one, and only one channel, on which they operate on.

### BRIEF SUMMARY OF THE INVENTION

B. Intend to invent and create, Intend to invent and create, ultra secure and ultra high throughput communication conduit and system, with simultaneous communication and data transfer through multiple channels. This novel design and system will work for back haul communication, internet access on devices, operating systems, servers and device to device, application to application, program to program, communication. Further with the novel, broker, channel select, and protocol interplex newer unique ways of ultra secure communication are possible.

B.1 Currently computer or mobile devices, applications or programs at any particular time use only one channel to communicate or send data to and fro or to access internet in general terms. Here channel means an already established means of data transfer like cellular, wifi etc with respect to a device, with this novel invention it will be possible to send data through multiple channel simultaneously, which will increase the throughput of data transfer significantly and make the communication secure.

B.2 Currently for back haul communication, most of the communication uses only one channel for data transfer at a time, here channel means, the communication medium like the the fiber optic, satellite, copper etc, with this novel invention when applied to the back haul, it will be possible to send data through multiple simultaneously, which will increase the throughput of data transfer significantly, further it is possible to specifically select the channel to which restrict the transfer to and make the communication secure.

B.3 As of today as all the data is sent through one channel, the data transfer throughput is not maxed out as the applications are using only one channel at a time, with this invention which make it possible to use simultaneous channels the data throughput can be maxed out. Also this novel invention gives an apparent (not actual but appears to be) increase in speed of data.

B.4 There exists not a program or system which can make the data transfer possible to use all the available communication channels for a device. And for the back haul communication, there exists not a way which can dictate which communication channel should be used, and also route or spread out between different channels. Also it is not possible for the same device to route and work on multiple channels at the same time. With this invention as described it is possible to dictate, or switch which channel to use for computer device, or use all the channel simultaneously. And on the same lines it is possible for the backhaul also to select which communication channel should be used. And it is possible with this technology to create new breed to network devices which can work on multiple channels at the same time and route traffic between them.

B.5 There exists not a program or system which can select which channel the communication should restrict to, and further as there are now higher speed channels compared to others, be able to specifically select a channel. With this novel invention as described it is possible to not only select the channel for communication or restrict the communication, to other channel or chose the channel having higher speeds of transfer possible.

B.6 Traditionally, so far the routing devices, switches have one, and only one channel, on which they operate on, with this technique and technology new breed of routing and switching devices is devised as described, which can take in multiple channels and route traffic.

### BRIEF DESCRIPTION OF THE SEVERAL VIEWS OF THE DRAWING

DW.1 Drawing 1: Pioneer ultra secure and ultra high throughput communication conduit with simultaneous communication and data transfer through multiple channels logical diagram.

DW.1.1 Drawing 1: Pioneer ultra secure and ultra high throughput communication conduit with simultaneous communication and data transfer through multiple channels logical diagram. Ultra Secure and High Throughput Conduit, is pioneer and innovative technology, with ability to use multiple channels simultaneously. This pioneer technology is the backbone of the of ultra high speed and secure transfer of data, making collaboration, trading, publishing of systems realtime. Further the conduit uses the “proximity aware” and “location distance aware” technology to active and use different channels as needed. Further as depicted in D.21

DW.1.2 1 “High Speed and high throughput Fiber” depicting the ultra high bandwidth, throughput and high speed fiber channel. High speed fiber is new hallow core fiber optics which has slightly higher speed of data transfer than normal fiber cables.

DW.1.3 2 “Cellular”, is cellular and radio communication channel, pertaining to various carriers, and radio signals.

DW.1.4 3 is “Satellite”, is the satellite communication through the satellite channel.

DW.1.5 4 is “Copper”, is the copper channel for communication.

DW. 1.6 5 is “Technology X” is generalization of all the technologies of communication wiz, radio, wifi, infrared, coaxial cable and any future technologies, as the conduit as described uses plug and play plugins making to onboard any technology of the present or future.

DW.2 Drawing 2: Ultra secure and ultra high throughput communication system with simultaneous communication and data transfer through multiple channels.

DW.2.1 Drawing 2: Ultra secure and ultra high throughput communication system with simultaneous communication and data transfer through multiple channels. The system as such uses inheritance principles, having generic interfaces, with concrete implementations for various interfacing entities which can be a device, computer device, server, router, switch, application, program etc. Further as described in D.2.

DW.2.2 1 “Plug and Play Interface”, is the interface which is used by the application or device or program or special devices like routers, switches, interact with the system as such, and be able to send and receive information and transfer data using simultaneous channels. Further as described in D.3.

DW.2.3 2 “Aggregator/Die-aggregator”, breaks the data as needed and sends/receives it across multiple channels or be selective about which channel to send the information to, and then combines it, further it uses “Protocol Interplexer”. Further as described in D.4.

DW.2.4 3 “Protocol Interplex”, is the unique technology which can use multiple different protocols to send information, further it can use payload of one protocol and encapsulate it on another protocol. Further it has the unique ability of protocol interplay, where the conversion layer built in the interplex, actively converts from one protocol to another. Further as described in D.5.

DW.2.5 4 “Wifi Channel Plugin”, is the plugin adapter which interfaces with the wifi and sends data through the wifi channel. Further as described in D.6.

DW.2.6 5 “Cellular Chanel Plugin”, is the plugin adapter which interfaces with the cellular and radio, sends data through the cellular channel. Further as described in D.6.

DW.2.7 6 “Bluetooth Channel Plugin”, is the plugin adapter which interfaces with the bluetooth and sends data through the bluetooth channel. Further as described in D.6.

DW.2.8 7 “Infrared Channel Plugin”, is the plugin adapter which interfaces with the infrared channel and sends data through the infrared channel. Further as described in D.6.

DW.2.9 8 “Satellite Plugin”, is the plugin adapter which interfaces with the satellite channel and sends data through the satellite channel. Further as described in D.6.

DW.2.10 9 “Lan”, is the plugin adapter which interfaces with the lan channel and sends data through the lan channel. Further as described in D.6.

DW.2.11 10 “Optical Fiber Channel”, is the optical fiber plugin adapter which interfaces with the optical channel and send data through the optical fiber channel. Further as described in D.6.

DW.2.12 11 “Technology X”, is the generalization of plugin adapter of all the technologies of communication e.g. coaxial cable, copper and any present or future technologies, as the system uses plugin adapter approach, making onboarding of any technology of the present or future. Further as described in D.6.

DW.2.13 12 “Broker”, is the multi factor out of system broker, which dictates which channel to use or not use, or randomize the channel selection for all or some data. D.7

DW.2.14 13 “Application”, is depicting an application how it can use the system as such to send data using multiple channels at same time.

DW.2.15 14 “Device”, is depicting a device how it can use the system as such to send data using multiple channels at the same time. Here a device can be any computer device with logic, such as mobile device, mobile phone, tablet, single chip microcontroller, embedded device etc.

DW.2.16 15 “Program”, is depicting a program how it can use the system as such to send data using multiple channels at same time.

DW.2.17 16 “Router”, is depicting a router can use the system as such to send data using multiple channels at same time.

DW.2.18 17 “Server”, is depicting an server how it can use the system as such to send data using multiple channels at same time.

DW.3 Drawing 3: Shows the example working of USAUHTASCCAS across two different computer devices. when using point to point communication.

DW.3.1 Drawing 3: Shows the example working of USAUHTASCCAS across two different computer devices, when using point to point communication. Here a computer device is a generalization, and a computer device, can be a computer, a mobile phone, server, router, switch, tablet, embedded device etc. The diagram shows how USAUHTASCCAS uses there different channels to establish connection and send data simultaneously through the three channels, from “computer device 1” to “computer device 2”.

DW.3.2 1 is an example of “computer device 1”, with USAUHTASCCAS installed in it, and having three active channels, wiz, Wifi, Cellular, Satellite.

DW.3.2 2 is showing the USAUHTASCCAS and communication and sending data through three different channels.

DW.3.2 3 is showing three different channels, wiz the wifi channel, the cellular channel and the satellite channel and the data being sent through these channels simultaneously.

DW.3.2 4 is an example of “computer device 2”, with USAUHTASCCAS installed in it, and having three active channels, wiz, Wifi, Cellular, Satellite.

DW.4 Drawing 4: Shows example button and icon, for “Universal Connection”, for normal internet connection but with the ability to use multiple channels at the same time to access the internet.

DW.4.1 Drawing 4: Shows the example working of USAUHTASCCAS on a device with the example “Universal Connection” button or function invocation, and icon, for normal internet connection but with the ability to use multiple channels at the same time to access the internet. In this example using this example button, internet can be accessed but multiple channels are used for communication and data transfer.

DW.4.2 1: Is the example button graphics, it is shown, “Wifi”, “Cellular”, “Lan”, “Satellite”, “Fiber”, “Bluetooth” under the button, depicted that the system can simultaneously communicate through these channels.

DW.4.2 2: Is the example icon as it appears on a device, in this case is showing on a mobile device.

DW.4.2 3: Is the example device, in this case it is mobile device, showing the icon on the top bar.

### DESCRIPTION

### Detailed Description of the Invention

P Intend to invent and create, Intend to invent and create, ultra secure and ultra high throughput communication conduit and system, with simultaneous communication and data transfer through multiple channels. This novel design and system will work for back haul communication, internet access on devices, operating systems, servers and device to device, application to application, program to program, communication. Further with the novel, broker, channel select, and protocol interplex newer unique ways of ultra secure communication are possible.

P.1 The system comprises of the conduit and the system as such which is set of computer, programs and libraries which make the conduct possible. Further as described in D.1 and from D.2 to D.8.

P.2 The aggregator and dis aggregator with broker AADAWB, which can brake the data, to send to multiple channels, and then can combine the data from the multiple channels using the aggregator and de-aggregator, further the broker can dictate the channel usage, making the communication highly secure. Further as described in D.2

P.3 Another unique feature of the system as such is protocol interplexer, which can use multiple protocols for same communication connection, and further payload of one protocol to encapsulate on another protocol and vice versa. Further as described in D.3

P.4 Currently computer or mobile devices, applications or programs at any particular time use only one channel to communicate or send data to and fro or to access internet in general terms. Here channel means an already established means of data transfer like cellular, wifi etc with respect to a device, with this novel invention it will be possible to send data through multiple channel simultaneously, which will increase the throughput of data transfer significantly and make the communication secure.

P.5 Currently for back haul communication, most of the communication uses only one channel for data transfer at a time, here channel means, the communication medium like the the fiber optic, satellite, copper etc, with this novel invention when applied to the back haul, it will be possible to send data through multiple simultaneously, which will increase the throughput of data transfer significantly, further it is possible to specifically select the channel to which restrict the transfer to and make the communication secure.

P.6 As of today as all the data is sent through one channel, the data transfer throughput is not maxed out as the applications are using only one channel at a time, with this invention which make it possible to use simultaneous channels the data throughput can be maxed out. Also this novel invention gives an apparent (not actual but appears to be) increase in speed of data.

P.7 There exists not a program or system which can make the data transfer possible to use all the available communication channels for a device. And for the back haul communication, there exists not a way which can dictate which communication channel should be used, and also route or spread out between different channels. Also it is not possible for the same device to route and work on multiple channels at the same time. With this invention as described it is possible to dictate, or switch which channel to use for computer device, or use all the channel simultaneously. And on the same lines it is possible for the backhaul also to select which communication channel should be used. And it is possible with this technology to create new breed to network devices which can work on multiple channels at the same time and route traffic between them.

P.8 There exists not a program or system which can select which channel the communication should restrict to, and further as there are now higher speed channels compared to others, be able to specifically select a channel. With this novel invention as described it is possible to not only select the channel for communication or restrict the communication, to other channel or chose the channel having higher speeds of transfer possible.

P.9 Traditionally, so far the routing devices, switches have one, and only one channel, on which they operate on, with this technique and technology new breed of routing and switching devices is devised as described, which can take in multiple channels and route traffic.

P.10 As the goal of the system is to achieve highest Interoperability, the libraries of the system is implemented in multiple programming languages. The first implementation being in with native functionality in C, C++, VC++ and subsequently in python, then java, c#, objective c. The interfaces written in cross platform frameworks, with mobile responsive and AR/VR convertible. The system is also resized as firmware, adapter agent, server application, mobile application, tablet application, AR/VR application, web application, desktop application, router firmware, switch firmware, hub firmware. There are two modes of invoking the system, one being the API interface of “Plug and Play” interface of the system, the other being implementation is the native implementation, where the libraries, firmwares are created, and embedded in the device OS and OEM. For all the functionality for all the modules are developed with SOA (service oriented architecture) with the API first approach with public, protected and private interfaces, these interfaces further makes the system very highly interoperable. Giving the system to simultaneously hosted on prem, data centers, and its own public cloud, for the UI interfaces, broker and managing of the conduit and system as such. The system uses other existing frameworks for mobile, tablet and AR/VR. The system also uses mysql, Postgres, file system along with very secure hash safe custom native persistent data structures, and data lake. Also as the system is implemented as SAAS in multi region, communication between its different multi region SAAS, across different geographies and countries.

### P.11 Glossary

Data: Data here represents the bit and bytes. These bit and bytes can make up anything for computers, including the high level term data.
Computer device: is loosely used to represent any electronic device with logic ability, and can be a computer, server, router, switch, mobile phone or tablet, embedded device, or any device.
Device: is any electronic device with programming logic
USAUHTASCCAS: Ultra Secure and Ultra High Throughput and Speed Communication Conduit and System.
Back haul communication: Back haul communication pertains to internet backbone, and pertains to the internet routers, the layer 1, layer 2, layer 3 devices and the physical communication channels.
Channel: Channel is broadly used in two contexts, for back haul communication, and secondly for device to device, program to program, or application to application communication, normal internet. For back haul communication, channels pertains to actual physical fiber optics, satellites and satellite communication, cooper cables, coaxial cables, and hence forth. For device to device, program to program, application to application communication or for normal internet, channel is communication network available to consume, e.g. wifi, cellular, bluetooth available on a computer.
   D.1 Detailed Description with Architectural Diagrams and Drawings, Working Communication Conduit

D.1.1 “Drawing 1 is the diagram which depicts the ultra high and ultra throughput, bandwidth and speed communication conduit. This conduit is made possible with novel systems as described in D.2 to D.8, and having the system as such deployed on the network devices, such as routes, switches. By having this new system deployed it becomes possible for the communication to span out at multiple points, to use multiple channels simultaneously or not. Also with the “channel aware” and “proximity aware” technology, the conduit with the system deployed as such can guide the traffic specifically to certain channels. These newer routes, switches, hubs, fiber optic termination points, when with the new system as deployed, become “Multi Channel Routers”, “Multi Channel Switches”, “Multi Channel Hubs” and in effect is the newer version of the ECB architecture.

D.1.2 Drawing 1: Pioneer ultra secure and ultra high throughput communication conduit with simultaneous communication and data transfer through multiple channels logical diagram. Ultra secure and high throughput conduit, is pioneer and innovative technology, with ability to use multiple channels simultaneously. This pioneer technology is the backbone of the of ultra high speed and secure transfer of data, making collaboration, trading, publishing of systems realtime. Further the conduit uses the “proximity aware” and “location distance aware” technology to activate and use different channels as needed. Further as depicted in D.

D.1.3 1 “High Speed and high throughput Fiber” depicting the ultra high bandwidth, throughput and high speed fiber channel. High speed fiber is new hallow core fiber optics which has slightly higher speed of data transfer than normal fiber cables. With this technology as such it is first time possible to control the channels to use for the data at the packet level.

D.1.4 2 “Cellular”, is cellular and radio communication channel, pertaining to various carriers, and radio signals.

D.1.5 3 is “Satellite”, is the satellite communication through the satellite channel.

D.1.6 4 is “Copper”, is the copper channel for communication.

D.1.7 5 is “Technology X” is generalization of all the technologies of communication wiz, radio, wifi, infrared, coaxial cable and any future technologies, as the conduit as described uses plug and play plugins making to onboard any technology of the present or future.

D.2 Detailed Description with Architectural Diagrams and Drawings, Working of USAUHTASCCAS

D.2.1 Ultra secure and ultra high throughput communication system with simultaneous communication and data transfer through multiple channels. The system as such is the implementation of the, ultra secure and ultra high throughput communication system with simultaneous communication and data transfer through multiple channels conduit and principal. The system as such adheres to the generic paradigm, where the system has interfaces of generic type, and then for each different implementation type, implementation of the interface differs. The system as such uses inheritance principles, having generic interfaces, with concrete implementations for various interfacing entities which can be a device, computer device, server, router, switch, application, program etc. With the major components modules being “Plug and Play Interface”, “Aggregator/De-aggregator”, “Protocol Interplex”, “Plugins” and Broker. The system exposes these functions through the API interface which sits in the “Plug and Play interface” and also, the system is implemented natively as a firmware, library and ddl. For the adherence of the interfaces as such, these firmware, dlls, libraries and specifically catered and open to modification with public, and protected classes and functions. Further in in the diagram each module, component is explained and further explained in each section. The system as such has multiple implementations with the same interface, the implementations are as an application, native dll for OEM, core components for operating system, c library, firmware or lightweight open program, catering to different scenarios.

D.2.2 The systems as such is used for point to point communication as show in “Diagram 3”, or for normal internet as depicted in an example in “Diagram 4”. The aggregator, de-aggregator work according based on whether its point to point mode, or normal internet mode. Lastly the system as such is used for routing and backhaul made possible by the conduit as depicted by D.1, D.8, when the system as such is installed on network devices.

D.2.3 Drawing 2: Ultra secure and ultra high throughput communication system with simultaneous communication and data transfer through multiple channels.

D.2.4 1 “Plug and Play Interface”, is the interface which is used by the application or device or program or special devices like routers, switches, interact with the system as such, and be able to send and receive information and transfer data using simultaneous channels. Further as described in D.3.

D.2.5 2 “Aggregator/Die-aggregator”, breaks the data as needed and sends/receives it across multiple channels or be selective about which channel to send the information to, and then combines it, further it uses “Protocol Interplexer”. Further as described in D.4.

D.2.6 3 “Protocol Interplex”, is the unique technology which can use multiple different protocols to send information, further it can use payload of one protocol and encapsulate it on another protocol. Further it has the unique ability of protocol interplay, where the conversion layer built in the interplex, actively converts from one protocol to another. Further as described in D.5.

D.2.7 4 “Wifi Channel Plugin”, is the plugin adapter which interfaces with the wifi and sends data through the wifi channel. Further as described in D.6.

D.2.8 5 “Cellular Chanel Plugin”, is the plugin adapter which interfaces with the cellular and radio, sends data through the cellular channel. Further as described in D.6.

D.2.9 6 “Bluetooth Channel Plugin”, is the plugin adapter which interfaces with the bluetooth and sends data through the bluetooth channel. Further as described in D.6.

D.2.10 7 “Infrared Channel Plugin”, is the plugin adapter which interfaces with the infrared channel and sends data through the infrared channel. Further as described in D.6.

D.2.11 8 “Satellite Plugin”, is the plugin adapter which interfaces with the satellite channel and sends data through the satellite channel. Further as described in D.6.

D.2.12 9 “Lan”, is the plugin adapter which interfaces with the lan channel and sends data through the lan channel. Further as described in D.6.

D.2.13 10 “Optical Fiber Channel”, is the optical fiber plugin adapter which interfaces with the optical channel and send data through the optical fiber channel. Further as described in D.6.

D.2.14 11 “Technology X”, is the generalization of plugin adapter of all the technologies of communication e.g. coaxial cable, copper and any present or future technologies, as the system uses plugin adapter approach, making onboarding of any technology of the present or future. Further as described in D.6.

D.2.15 12 “Broker”, is the multi factor out of system broker, which dictates which channel to use or not use, or randomize the channel selection for all or some data. D.7

D.2.16 13 “Application”, is depicting an application how it can use the system as such to send data using multiple channels at same time.

D.2.17 14 “Device”, is depicting a device how it can use the system as such to send data using multiple channels at the same time. Here a device can be any computer device with logic, such as mobile device, mobile phone, tablet, single chip microcontroller, embedded device etc.

D.2.18 15 “Program”, is depicting a program how it can use the system as such to send data using multiple channels at same time.

D.2.19 16 “Router”, is depicting a router can use the system as such to send data using multiple channels at same time.

D.2.20 17 “Server”, is depicting an server how it can use the system as such to send data using multiple channels at same time.

D.3 Detailed Description with Architectural Diagrams and Drawings, Working of Plug and Play Interface

D.3.1 The plug and play interface make it possible for other devices, operating systems, applications, programs, to communicate with the system as such. The plug and play interface, follows the generic paradigm, having a generic interface and the specially the interface implemented to each different usage, device or application type. The plug and play interface many exposes the functionality an API or as native implementation.

D.3.2 API: The plug and play interface exposes restful api, all the public functions of the system as such. The restful api is designed with simple one endpoint invocation, for simple interactions. And further for elaborate interactions, all the public interfaces and resources are exposed through the restful API. The whole application is created with SOA (service oriented architecture) with API first approach.

D.3.3 Native: In native implementation, the plug and play interface is specifically coded for a particular OEM, OS, Device, Server or Router and is embedded in the core libraries. Secondary a generic library too is, with the default implementation of the interface.

D.3.3 Also the plug and play interface makes it possible for the consuming, devices, programs, operating systems to display one “universal connection”, which give the hosted application, programs, to use all communication channels at the same time or in other words internet access through multiple channels.

D.4 Detailed Description with Architectural Diagrams and Drawings, Working of Aggregator and De-Aggregator

D.4.1 The aggregator/de-aggregator is at the core of the system. The de-aggregator is responsible for breaking the data, sending it across multiple channels, and the aggregator, combining it again after receiving it from different channels. It relies on two modes of communication, native and abstract. Further the aggregator, de-aggregator, work for point to point communication, or for normal internet (in other words internet access through multiple channels), or for network routing across multiple channels.

D.4.2 Abstract: In abstract mode, socket connection for each channel (using the channel plugin) are opened, and the data is broken, and the broken data is sent to open sockets for each channel. Further with the broker in play, the broker can send instructions to, select which channel, or use randomness to send broken data on one channel or other or both. The “Protocol Interplexer” is rarely used in this mode, and the communication is sent to the appropriate plugin for that channel. Further the initial modes and initial algorithm, are described in the section D.4.3. This mode is mostly used for normal internet, device, server, program, device to device, server to server, server to client, program to program communication, and really used at router, switch level routing.

D.4.3 Native: In the native mode, the aggregator/De-aggregator creates the broken up data packets, having network headers with channel selection and broker dictation, and sends to, protocol interplexer, the protocol interplexer choses the right protocol for the channel and create native packets with the header information, for that protocol and sends to the appropriate plugin. This mode is mostly used for “multi channel router”, “multi channel switch”. Further section D.8.4 lists the various header codes that are used.

### D.4.4 Modes and Algorithm.

Active Channel throughput and speed calculation and feedback. ACTASC. Is the mechanism which actively monitors the throughput, speed, and actively sends feedback for a particular channel. Using ACTASC most of the other modes, and algorithms decide the optimal working.
Fixed length breakup:
   In this mode, before hand the full length of the data is known. The data is broken in pieces after using the ACTASC, and based on the channel throughput chunks are determined. Each chunk is sent to channel, and simultaneously send to different channels. The chunks are numbered, the chunk information is sent to the and is combined on the receiving side.
Per packet channel selection with advanced calculation with feedback.
   In this mode using the ACTASC, based on packet capacity of each channel, that number of packets are sent on that channel, and received. With active numbering, feedback, packets are combined on the receiving end.
Special Streaming:
   Content Separation per channel
      In this mode the content itself is separated per channel. E.g. audio is sent to one channel, and video is sent to another channel.
Application channel select mode:
   This is application by application selection mode. In this mode for an application a particular channel is selected and communication is made through that, and switching to another channel based on ACTASC.
Broker Mode
   Channel Select:
      In this mode only certain channels are selected based on the broker dictation and data is sent only those channels. On the receiving side, broker is used again to read data from the dictated channels, and other channels are ignored.
   Channel Select with Randomization:
      In this mode, channel are randomly used as dictated by the broker, and on the receiving side the data read. Further
Stateless Mode.
   In this mode, stateless object or resources, using the ACTASC are sent to a channel and served. In this mode no state is maintained for transfer as each object or resource is requested completely using a channel and served.
Adaptive;
   This mode using the ACTASC actively changes from one mode to another, based on performance and broker dictation.
Point to point mode:
   Here two different end points make up of communication, and the de-aggregator at one end sends the broken up data across different, aggregator on the other end combines the data from the various channels and vice versa. For the system to work in this mode, both the participating entities should have this system installed.
Normal Internet Mode:
   In normal internet mode, the system is used to access normal internet but be able to use all the channels simultaneously. Here the de-aggregator, sends the communication requests, data, to multiple channels to internet, and when the response received, the aggregator combines the communication response, data, from multiple channels. The system as such is able to detect if the request being sent to has “this” system installed and works accordingly in that case.
Broker Mode:
   In this mode he broker is used as described. This specifies if the broker is used and which broker is being used.
Multi Channel Network Routing mode:
   This mode is used by the “Multi Channel Router”, “Multi Channel Switches” and Multi channel network devices, for network functions.

D.4.5 Proximity aware: Using the ACTASC the system as such keeps track of the channels proximity range, and destination proximity when possible, and based on the information, activates or deactivates a channel, or choses or not-choses a channel for single channel or simultaneous channel communication.

D.4.6 Location distance aware: Using ACTASC the system as such keeps track of the channels location range, and destination proximity when possible, and based on the information, activates or deactivates a channel, or choses or not-choses a channel for single channel or simultaneous channel communication.

D.4.7 Using the ACTASC, the system as such is able to not only activate, deactivate a channel but can also, switch the connections from one channel to another if its down, or is there is degradation.

D.5 Detailed Description with Architectural Diagrams and Drawings, Working of Protocol Interplexer

D.5.1 This is the unique technology which can use multiple different protocols to send information, further it can use payload of one protocol and encapsulate it on another protocol. Further it has the unique ability of protocol interplay, where the conversion layer built in the interplex, actively converts from one protocol to another.

D.5.2 Protocol interplexer, uses multiple protocols for same communication connection across different channels or different channels, it does so by using the ACTASC, and actively based on the feed back sends packets to multiple protocols across different channels. Further with broker interplay as needed, on protocol selection.

D.5.3 When used for routing and network routing, the protocol interplexer, choses the right protocol for the channel and create native packets with the header information, for that protocol and sends to the appropriate plugin. This mode is mostly used for “multi channel router”, “multi channel switch”.

D.6 Detailed Description with Architectural Diagrams and Drawings, Working of Plugin Adapters

D.6.1 Plugin adapters make it possible for the system to interface with different channels, establish connections and send data across them. All the plugins drive from the same “plugin” interface, with different implementations pertaining to underneath technology. For each channel there are two corresponding implementations, as each plugin is broadly implemented twice one for back haul communication, and one for device, application or program implementation.

D.6.2 For back haul communication, the plugins implement the interface with special functions to interface directly with the direct channel.

D.6.3 For device, application or program implementation, general internet access, the plugin uses the abstract implementation already provided by the device os or OEM, and very rarely implements the special interface functions to interface with the direct channel.

D.6.4 The initial plugins implemented are, Wifi Channel Plugin, Cellular Channel Plugin, Optical Cable Plugin, Satellite Channel Plugin, Infrared Channel Plugin, Lan (Ethernet) Channel Plugin, Coaxial Channel Plugin. Also it is possible to develop plugin for any new technology.

D.7 Detailed Description with Architectural Diagrams and Drawings, Working of Broker with Channel Select

D.7.1 Broker is the program or application, and is installed not on the device on which the system is installed and is installed on the other device or embedded in the broker application. The broker add extra layer of security by dictating which channel to use or not use and also add randomness. The broker mode is depicted in D.4.3 for aggregator/de-aggregator.

D.7.2. Channel select. In channel select mode, the broker externally dictates which channel to use and which channel not to use, or which channel to stop using and start using as needed. Further section D.8.4 lists the various codes that are used by the broker.

D.7.3 Randomness: In the randomness mode, the broker, selectively dictates and add randomness to the channel selection.

D.8 Detailed Description with Architectural Diagrams and Drawings, Working of Multi Channel Routing Devices

D.8.1 Traditionally, so far most of the routing devices have one, and only one channel, on which they operate on. With this technique and technology new breed of routing and switching devices is devised as described, which operate on multiple channels at the same time.

D.8.2 To describe further as of now a lan switch only works on cat 5 cable. With this new technology and the new system as installed, a switch can simultaneously, have wifi, cat 5, fiber optic end point, radio and bluetooth, inputs with routing abilities.

D.8.3 The new routing device names will be “Multi Channel Switch”, “Multi Channel Router”. Drawing 2, shows the generalization, of the system as such for a router. The same generalization when applied to routing logic, “Multi Channel Switch”, “Multi Channel Router” is possible.

D.8.4 These newer devices uses the channel information in the network packet headers. Following are the channel codes used in the network headers. The channel codes keep adding as per newer technologies.

| | |
|---|---|
| Wifi Channel: | 0000WF |
| Satellite Channel: | 0000ST |
| Cellular Channel: | 0000CL |
| Radio Channel: | 0000RD |
| Copper Channel: | 0000CP |
| Bluetooth Channel: | 0000BL |
| Infrared Channel: | 0000IR |
| Optical Fiber Cable: | 0000FC |
| Optical Fiber Cable with hallow core: | 000HFC |
| And hence forth | |

D.9 Detailed Description with Architectural Diagrams and Drawings, Working of Different Sub Systems, Systems and Interactions Between Them′

D.9.1 Drawing 3: Shows the example working of USAUHTASCCAS across two different computer devices. Here a computer device is a generalization, and a computer device, can be a computer, a mobile phone, server, router, switch, tablet, embedded device etc. The diagram shows how USAUHTASCCAS uses there different channels to establish connection and send data simultaneously through the three channels, from “computer device 1” to “computer device 2”.

D.9.2 1 is an example of “computer device 1”, with USAUHTASCCAS installed in it, and having three active channels, wiz, Wifi, Cellular, Satellite.

D.9.3 2 is showing the USAUHTASCCAS and communication and sending data through three different channels.

D.9.4 3 is showing three different channels, wiz the wifi channel, the cellular channel and the satellite channel and the data being sent through these channels simultaneously.

D.9.5 4 is an example of “computer device 2”, with USAUHTASCCAS installed in it, and having three active channels, wiz, Wifi, Cellular, Satellite.

D.9.6 Drawing 4: Shows example logo for “Universal Connection”, for normal internet connection but with the ability to use multiple channels at the same time to access the internet.

D.9.8 Drawing 4: Shows example button and icon, for “Universal Connection”, for normal internet connection but with the ability to use multiple channels at the same time to access the internet.

D.9.9 Drawing 4: Shows the example working of USAUHTASCCAS on a device with the example “Universal Connection” button or function invocation, and icon, for normal internet connection but with the ability to use multiple channels at the same time to access the internet. In this example using this example button, internet can be accessed but multiple channels are used for communication and data transfer.

D.9.10 1: Is the example button graphics, it is shown, “Wifi”, “Cellular”, “Lan”, “Satellite”, “Fiber”, “Bluetooth” under the button, depicted that the system can simultaneously communicate through these channels.

D.9.11 2: Is the example icon as it appears on a device, in this case is showing on a mobile device.

D.9.12 3: Is the example device, in this case it is mobile device, showing the icon on the top bar.

D.9.13 As the goal of the system is to achieve highest Interoperability, the libraries of the system is implemented in multiple programming languages. The first implementation being in with native functionality in C, C++, VC++ and subsequently in python, then java, c #, objective c. The interfaces written in cross platform frameworks, with mobile responsive and AR/VR convertible. The system is also resized as firmware, adapter agent, server application, mobile application, tablet application, AR/VR application, web application, desktop application, router firmware, switch firmware, hub firmware. There are two modes of invoking the system, one being the API interface of “Plug and Play” interface of the system, the other being implementation is the native implementation, where the libraries, firmwares are created, and embedded in the device OS and OEM. For all the functionality for all the modules are developed with SOA (service oriented architecture) with the API first approach with public, protected and private interfaces, these interfaces further makes the system very highly interoperable. Giving the system to simultaneously hosted on prem, data centers, and its own public cloud, for the UI interfaces, broker and managing of the conduit and system as such. Further agents of app media streaming protocols implemented which and encapsulated behind the API, and streaming engine. The system uses other existing frameworks for mobile, tablet and AR/VR. The system also uses mysql, Postgres, file system along with very secure hash safe custom native persistent data structures, and data lake. Also as the system is implemented as SAAS in multi region, communication between its different multi region SAAS, across different geographies and countries.

Identifying indicia: Application Title: Ultra secure and ultra high throughput communication conduit and system, with simultaneous communication and data transfer through multiple channels.

### DRAWINGS

### Identification of Drawings

Drawing 1: Pioneer ultra secure and ultra high throughput communication conduit with simultaneous communication and data transfer through multiple channels.

Drawing 2: Ultra secure and ultra high throughput communication system with simultaneous communication and data transfer through multiple channels.

Drawing 3: Shows the working of USAUHTASCCAS across two different computer devices, when using point to point communication.

Drawing 4: Shows example button and icon, for “Universal Connection”, for normal internet connection but with the ability to use multiple channels at the same time to access the internet.

1: Claim to invent and create, ultra secure and ultra high throughput communication conduit and system, with simultaneous data transfer through multiple communication channels, which works for back haul communication, internet access on devices, operating systems, servers and device to device, application to application, program to program, communication, USAUHTASCCAS.

2: Claim to invent and create, aggregator and dis aggregator with broker AADAWB, which can brake the data, to send to multiple channels, and then can combine the data from the multiple channels using the aggregator and dis-aggregator, further the broker can dictate the channel usage, making the communication highly secure.

3: Claim to invent and create, protocol interplexer, where the protocol interplexer uses multiple protocols for same or different communication connection over multiple channels, and further payload of one protocol to encapsulate on another protocol and vice versa.
